(19) United States
(12) Patent Application Publication
(10) Pub. No.: US 2002/0103796 A1
(43) Pub. Date: Aug. 1, 2002

(54) Method for parametrically sorting music files

(75) Inventor: Peter Hartley, Cambridge (GB)

Correspondence Address: Julie L. Reed, MARGER JOHNSON & McCOLLOM, P.C., 1030 S.W. Morrison Street, Portland, OR, 97205, US

(73) Assignee: SONICblue, Inc., Santa Clara, CA (US)

(21) Appl. No.: 09/773,956

(22) Filed: Jan. 31, 2001

(51) Int. Cl. G06F 7/00

(52) U.S. Cl. 707/4

(57) ABSTRACT

A method for sorting music files. A parameter to be used in sorting is selected, either by the player or by the user. A random number is generated and weights are assigned to the parameter and the random number. These values are then used to calculate sorting criteria for each file. The files are then sorted by their sorting criteria, generating a playlist.

### BACKGROUND

1. Field

This disclosure relates to sorting music files in music players, more particularly for a method for determining the sort order of the music files.

2. Background

Digital music players have become more prevalent in the audio electronics market. These players allow users to store music as data files and access the files with the player for production of audio output. They have several advantages over other types of music players. For example, a portable compact disc (CD) player requires a relatively high amount of power, as the CD player has to have a motor to spin the disc to the appropriate track selected by the user, as well as to allow reading out of the audio data. This consumes batteries at a high rate, requiring frequent recharging or replacement of batteries.

Additionally, CD and tape cassette sources of music are organized by location. If the user customizes the playlist from a CD, for example, by selecting an order in which the tracks should be played, the CD player will access those tracks by spinning the disc to the appropriate location of the data. In digital music players, the music files are easier to organize, as they are comprised of digital data stored in a memory. This allows customization of playlists to be handled more efficiently.

This particular aspect of having the music in data files has given rise to new features available to the users. For example, software made available from Mserv (locally centralized music server environment), an organization that provides music file management software, allows users to customize playlists for each user. This software has several features that allow users to download music to a PC, and then manage what files are played and when.

For example, Mserv allows the user to list the available albums for play, list tracks on an album, provide information about the track, including album name, author, date, duration, genre, how long ago played, and rated. The user can provide ratings for each track, for example, and the mean rating for tracks is computed based upon the ratings provided for all users that are connected to the Mserv system.

It is possible to command the player to play the files in random order. This is a feature that is available on many different players. Most implement random play or ‘shuffling’ using a random number generator. The random number generator assigns a number for each track and then sorts the random numbers into a playlist.

Using Mserv software as an example, the user can activate a RANDOM function. The function sorts the tracks based upon their ratings. There is a random power/log function that provides the randomness of the track selection that can be controlled to designate to which way the ratings are swayed, towards higher rated tracks or lower rated tracks.

However, there are several limitations inherent is systems such as Mserv. No system exists that allows the user to control the playlist with factors other than user ratings meaning that the user cannot select the basis of the sort, and no system exists that gives the user complete control. For example, in Mserv, the system administrator of the server has control over some of the functions.

Therefore, a method that allows users more control and flexibility of their playlists on all types of music players would seem useful.

### SUMMARY

One aspect of the disclosure is a method for sorting music files. A parameter to be used in sorting is selected, either by the player or by the user. A random number is generated and weights are assigned to the parameter and the random number. The weights may be predetermined by the player, or provided by the user. These values are then used to calculate sorting criteria for each file. The files are then sorted by their sorting criteria, generating a playlist.

Another aspect of the disclosure is a method for allowing the user to define new parameters for the sorting criteria. The player provides the user with an interface for defining the parameter, allows the user to define the parameter and then receives ratings from the user for each file according to the new parameter. The rating is then assigned to each file. Optionally, the user can also assign a weight to be used for that parameter in the subsequent sorting calculation.

### BRIEF DESCRIPTION OF THE DRAWINGS

The invention may be best understood by reading the disclosure with reference to the drawings, wherein:

FIG. 1 shows one embodiment of a music player having a user input device, in accordance with the invention.

FIG. 2 shows a flowchart of one embodiment of a method for sorting music files, in accordance with the invention.

FIG. 3 shows a flowchart of one embodiment of a method for providing a user interface that allows users to define parameters for sorting music files, in accordance with the invention.

### DETAILED DESCRIPTION OF THE EMBODIMENTS

Digital music players come in many forms. However, most of them have several common characteristics. Most include a display of some sort and user input devices such as buttons, slider bars, rotary dials, and/or a stylus, if the display is also a touch screen. The players also have storage for storing the music files, circuitry for using the data stored in those files, and a decoder, if necessary. Decoders are used to convert compressed digital signals into the data used to the audio signals. The compression may be of any type and allows the player to use less storage to store the files. A compression format becoming very prevalent is that of MP3, (Moving Pictures Expert Group, audio layer 3), as an example, although other types of compression are equally applicable.

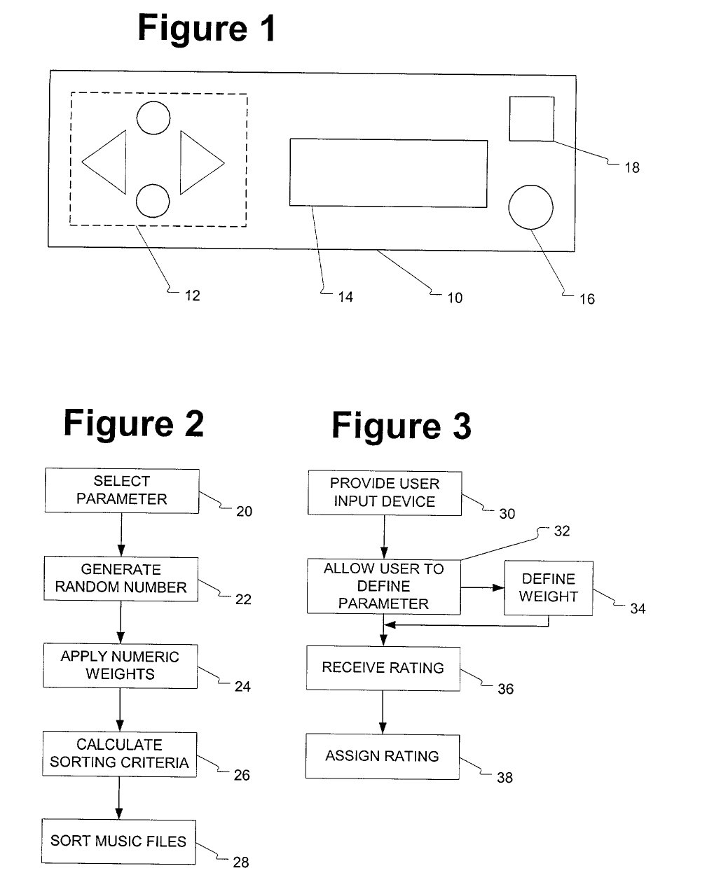

An example of the front panel of such a music player is shown in FIG. 1. The music player 10 has control buttons 12, as a user input device, a display 14 and a rotary dial 16. A window 18 may include an infrared port for communicating with other devices, as well as status indicators, such as light-emitting diodes (LEDs). The user may use the control buttons in group 12 to make selections from menus or other options presented on the display 14.

These players are typically portable, either being handheld or mountable in a vehicle such as a car or boat. The user loads music files onto the device by connecting the player to a source of the files, either through a personal computer (PC) or otherwise. For example, the user could connect the player to a PC using one of the available connection protocols, such as USB (Universal Serial Bus), Ethernet, infrared, or a RS-232 cable. The user would then be able to download music files from the PC to the player.

Once downloaded into the player, these files can be played by the user by selecting the files representing the songs. The number of files holding songs stored on the player depends upon the size of the memory in the player, as well as the amount of compression used to store the files. As mentioned above, many players afford the users the ability to play music in random order. However, a combination of random selection and some sort of preference would be useful.

Sorting by preference alone may not afford enough randomness to the user. For example, a user may select to have the files sorted such that those played least recently come up first. Of course, this could be just as easily sorted by other parameters, as will be discussed in more detail further in the discussion. However, this will result in the files being played in a specific order every time the feature is selected.

Similar to current random play selection on music players, a random number generator can be introduced to provide a mixing factor into the selection. The player then performs a calculation based upon the selected parameter, the random number and numeric weights applied to each. As used here, parameters include any property of the file that is tracked by the player. These include, but are not limited, to: time since last played, year recorded, play length, beats per minute, number of times played, and number of times skipped. Other user-defined parameters may be used, as discussed in more detail below.

FIG. 2 shows a flowchart of one embodiment of parametric shuffling of music files. At 20, the user selects the parameter to be used in sorting and ordering the music files. The user may select the parameter to be used in the shuffle from a menu. The player would display a menu on its display and the user could use the control buttons to select the parameter to be used. The player would then calculate sorting criteria for each file. At 22 a random number is generated for a particular music file.

This weighting is applied to each file for a particular parameter, P, and the random number, R at 24. A different random number is generated for each file. Otherwise, each file having the same value for the selected parameter would end up with the same sorting criteria. The setting of these weights is discussed in more detail below. The sorting criterion, which is typically a numeric value, is calculated at 26. One example of such a criteria is shown below.

S=P*Wₚ+R*Wᵣ

where S is the sorting criteria, P is the selected parameter, Wₚ is the weight assigned to the parameter, R is the random number, and Wᵣ is the weight assigned to the random number.

The following example is for illustrative purposes only, and is in no way intended to limit application of the invention. The parameter selected in this example is the time since a particular file has been played, in seconds, divided by 32. A limit is set on the time at 32767 seconds. Taking 32767*32 equals 1,048,544 seconds, or about 12 days. The value is chosen to be a 15-bit number (0-32767).

Similarly, the 15-bit limitation, while only an example, allows for easier processing in the player as the resulting sum will be less than 32 bits. Therefore, the random number will be selected to be between 0 and 32767, The weight for the time is set equal to 32767 and the weight for the random number is set at 2000, which expressed as a percentage would be 2000/32767, or about 6%. The resulting calculation for that particular file is then:

S=P*32767+R*2000.

As mentioned above, the weighting of the parameter versus the random number can be determined in many ways. For example, the user could be offered a series of choices for sorting by time since last played. A choice of “Actual Order” may cause the player to calculate only based upon the time since last played. This effectively makes the weighting of the random number equal to zero. At the opposite end of the ordering would be to have the order be completely random, which would alleviate any ordering based upon the selected parameter. Intermediate choices could be offered that would be “Nearly Actual Ordering” with a weight of 20% provided for the random number and several settings in between. In these examples, the user would select from a series of predefined randomness settings.

Alternatively, the player could automatically provide the randomness factor without any user input beyond the selection of the parameter. This may be an option for a less expensive version of the player, as it does not require as much processing power since no user interaction is necessary and the randomness factor may be stored in a register rather than calculated. Yet another alternative may offer the user the ability to select the relative weights of the parameter versus the randomness factor. Other possibilities exist for the determination of the weightings and these are only intended as examples. Once the calculations are performed for each file, the files are sorted according to their sorting criteria, resulting in a playlist of files.

More sophisticated users may desire to set their own parameters. A user may have a desire to sort by their own categories, such as ‘suitability for dancing,’ or ‘good for driving.’ The user would define the parameter by name, typically entered through the control buttons in conjunction with the display. The user could then define the range of values for that parameter, such as a scale of 1 to 10, 1 to 5 or other values. As each song title is displayed on the music play display, the user would then be able to enter the value for that particular parameter for that file. The user could even command the player to not include a particular file by giving it a ‘0’ value, or not assigning a value to it at all. The player would then perform the shuffle on only those files having a value for a particular user-defined parameter, allowing the user to eliminate files that do not fit a particular category.

A flowchart of one embodiment of a method to allow the user to define parameters in this fashion is shown in FIG. 3. The player provides a user input device by offering a menu or prompt for the user to define the new parameter at 30. The player would then allow the user to define the parameter, which may or may not include defining a range of values or a yes/no value for that parameter at 32. Any subjective criterion may be converted into a numerical parameter through a combination of ranking and enumeration. For example, the user may provide the ratings of “low, very low, high, very high and medium.” This could be ordered into “very low, low, medium, high, very high” and values assigned of 1-5, with 1 being the lowest.

An optional step 34 would also allow the user to define a weight to be used with that particular parameter versus the randomness factor. For example, if the user defines a parameter of ‘suitability for dancing’ and wants there to be only a limited amount of randomness, the user may set the parameter weight at 80 percent. This will ensure that the largest influence on the playlist is the ‘dance-ability’ of the music.

Once the user defines the parameter and, if desired, the weight, the user will need to provide the rating of each file within that parameter. The player receives this rating at 36 and associates it with the particular file at 38. The association of the rating and the rating definitions may be kept in a separate file, such as a database, for the current files on the player. These new parameter ratings are then used in the sorting calculation to allow sorting of the files in accordance with the new parameter.

Generally, the method of sorting music files will typically be distributed as software for existing players or including in the operating software of new players. The software could be distributed as a diskette or CD-ROM for the user to load into a PC and then download into the player. Alternatively, the user could download the new software from the Internet or other network. In some cases, the player may be directly connectable to the network, with its own connector and connection software. Regardless of how the software is obtained, it will be included on some sort of computer-readable medium that contains the necessary code. The code, when executed, will result in the methods of the invention discussed above.

In this manner, additional capabilities are provided to music players. The players can now shuffle the music files according to some parameter, with a controllable randomness factor to offer variety.

Thus, although there has been described to this point a particular embodiment for a method and apparatus for parametrically shuffling music files, it is not intended that such specific references be considered as limitations upon the scope of this invention except in-so far as set forth in the following claims.

What is claimed is:

1. A method for sorting music files, the method comprising:
a) selecting at least one parameter;
b) generating a random number;
c) applying numeric weights to the at least one parameter and the random number; and
d) calculating a sorting criteria based upon the numeric weights and the at least one parameter and the random number; and
e) sorting the music files according to the sorting criteria.

2. The method of claim 1 wherein the at least one parameter is defined by the user.

3. The method of claim 1 wherein the at least one parameter is a predefined parameter.

4. The method of claim 1 wherein the at least one parameter is a predefined parameter selectable by the user from a user input device.

5. The method of claim 1 wherein the at least one parameter is selected from the group comprised of: time since last played, year recorded, play length, beats per minute, number of times played, and number of times skipped.

6. The method of claim 1 wherein the at least one parameter is defined by the user through a user input device.

7. A method for providing a user interface for defining parameters used in shuffling music files, the method comprising:
a) providing a user input device;
b) allowing the user to define a parameter through the user input device;
c) receiving a rating for a music file through the user input device; and
d) assigning the rating received to the music file.

8. The method of claim 7, wherein the user input device further comprises a menu and at least one selection button.

9. The method of claim 7, wherein allowing the user to define a parameter further comprises defining a weight to be assigned to that parameter.

10. A computer-readable medium having included thereon software code that, when executed results in:
a) selection of at least one parameter;
b) generation of a random number;
c) application of numeric weights to the at least one parameter and the random number; and
d) calculation of a sorting criteria based upon the numeric weights and the at least one parameter and the random number; and
e) a sort of the music files according to the sorting criteria.

11. The computer-readable medium of claim 10, wherein the medium further comprises a diskette.

12. The computer-readable medium of claim 10, wherein the medium further comprises a CD-ROM.

13. The computer-readable medium of claim 10, wherein the medium further comprises a downloadable file.
